(19) United States
(12) Patent Application Publication
(10) Pub. No.: US 2024/0328114 A1
(43) Pub. Date: Oct. 3, 2024

(54) OPERATOR CAB FOR UNDERGROUND MINING MACHINES WITH UTILITY COMPARTMENT

(71) Applicant: Caterpillar Underground Mining Pty. Ltd., Tasmania (AU)

(72) Inventors: Manoj KUMAR, Varthur (IN); Sean Robert Saward, Penguin (AU)

(73) Assignee: Caterpillar Underground Mining Pty. Ltd., Tasmania (AU)

(21) Appl. No.: 18/621,558

(22) Filed: Mar. 29, 2024

(30) Foreign Application Priority Data
Mar. 31, 2023 (IN) 202311024477

(51) Int. Cl. E02F 9/16; E02F 9/08; E21F 13/02

(52) U.S. Cl. CPC E02F 9/166; E21F 13/02; E02F 9/0841

(57) ABSTRACT

An operator cab for an underground mining machine includes a floor portion, an opening to access an interior space of the operator cab, and a seating assembly for the operator cab. The seating assembly includes an operator seating unit, a raiser, and a utility compartment. The operator seating unit is mounted on the floor portion and is housed within the interior space of the operator cab. The raiser defines a surface to mount the operator seating unit thereon. The surface is elevated from the floor portion to raise the operator seating unit with respect to the floor portion. The utility compartment is positioned between the surface and the floor portion and defines an aperture directed towards the opening.

### TECHNICAL FIELD

The present disclosure relates to an underground mining machine. More particularly, the present disclosure relates to a utility compartment positioned under an operator seating unit of an operator cab of an underground mining machine.

### BACKGROUND

Underground mining machines, such as underground wheel loaders, are generally made to operate in harsh, rigorous environments of worksites, such as an underground mine. Such machines are also mostly required to be designed to be compact and/or space efficient so as to be easily maneuverable within the limited confines of the underground mine. Operators (e.g., physical onsite operators) of such machines may be required to spend significant amount of time, e.g., up to eight hours or more, within the underground mine, and may require items, such as food and water, e.g., for general comfort, energy, and/or proper hydration.

Japanese publication no.: 2002121769 relates to a construction machine. The construction machine may include one or more of a hydraulic excavator, a hydraulic shovel, a hydraulic crane, and the like machines, in which a space defined in a footrest or pedestal of a driver's seat can be used for storing objects.

### SUMMARY OF THE INVENTION

In one aspect, the disclosure relates to an operator cab for an underground mining machine. The operator cab includes a floor portion, an opening to access an interior space of the operator cab, and a seating assembly for the operator cab. The seating assembly includes an operator seating unit, a raiser, and a utility compartment. The operator seating unit is mounted on the floor portion and is housed within the interior space of the operator cab. The raiser defines a surface to mount the operator seating unit thereon. The surface is elevated from the floor portion to raise the operator seating unit with respect to the floor portion. The utility compartment is positioned between the surface and the floor portion and defines an aperture directed towards the opening.

In another aspect, the disclosure is directed to an underground work machine. The underground mining machine includes an implement to alter earth, a first frame portion and a second frame portion, and an operator cab. The first frame portion and the second frame portion are articulatable with respect to each other. The first frame portion movably supports the implement. The operator cab is supported by the second frame portion. The operator cab includes a floor portion, an opening to access an interior space of the operator cab, and a seating assembly for the operator cab. The seating assembly includes an operator seating unit, a raiser, and a utility compartment. The operator seating unit is mounted on the floor portion and housed within the interior space of the operator cab. The raiser defines a surface to mount the operator seating unit thereon. The surface is elevated from the floor portion to raise the operator seating unit with respect to the floor portion. The utility compartment is positioned between the surface and the floor portion and defines an aperture directed towards the opening.

### BRIEF DESCRIPTION OF THE DRAWINGS

FIG. 1 is a side view of an exemplary machine, such as an underground mining machine, having an operator cab, in accordance with one or more aspects of the present disclosure;

FIG. 2 is a view illustrating an operator accessing one or more items disposed within an interior space of the operator cab, in accordance with one or more aspects of the present disclosure;

FIGS. 3 through 5 are various view of a seating assembly positioned within the interior space of the operator cab, in accordance with one or more aspects of the present disclosure;

FIG. 6 is a view of an exemplary utility compartment of the seating assembly of FIGS. 3 through 5, in accordance with one or more aspects of the present disclosure; and

FIG. 7 is an exemplary utility compartment, in accordance with an alternate embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1, 1″, 101 and 201 could refer to one or more comparable components used in the same and/or different depicted embodiments.

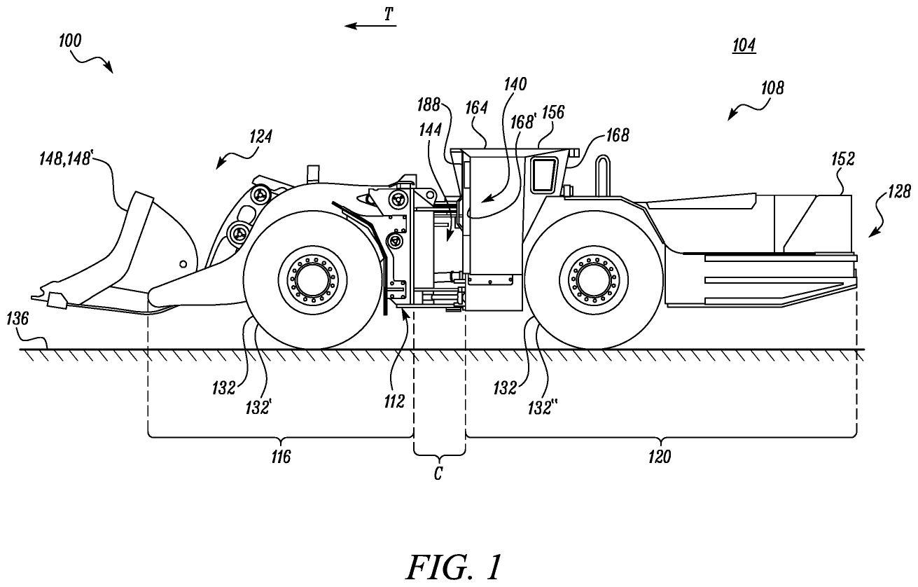

Referring to FIG. 1, an exemplary machine, i.e., a machine 100, is shown. The machine 100 may be a work machine that may be powered, either partly or fully, by electricity and/or by combustion of fossil fuels. The machine 100 may be applied at a worksite 104 that may correspond to a mining environment. As an example, the machine may exemplarily embody a load-haul-dump (LHD) machine or an underground mining machine 108, which may be applicable in an underground mining environment. It is however possible for the machine 100 to embody other types of machines usable in other environments, such as over ground mining environments, construction environments, and transportation environments. Therefore, aspects of the present disclosure may be applied to various other work machines and the machine 100 may not be limited to an LHD machine or the underground mining machine 108.

The machine 100 may include a main frame assembly 112. The main frame assembly 112 may exemplarily include a split frame configuration and may include a first frame portion 116 and a second frame portion 120. The first frame portion 116 may define a forward end 124 of the machine 100, while the second frame portion 120 may define a rearward end 128 of the machine 100. The machine 100 may further include traction devices 132 to propel the machine 100 with respect to a ground surface 136—e.g., the first frame portion 116 may support forward wheels 132′, while the second frame portion 120 may support rearward wheels 132″.

The machine 100 may also define one or more lateral sides, e.g., a left side 140 and a right side (the right side of the machine is not shown as it is hidden behind the left side 140 in the orientation of the machine 100 shown in FIG. 1). The first frame portion 116 and the second frame portion 120 may define a clearance, referred to as frame clearance, C, therebetween. The frame clearance, C, allows said frame portions (i.e., the first frame portion 116 and the second frame portion 120) to articulate with respect to each other, e.g., about a hitch joint 144. It may be noted that the frame clearance, Cl, may vary during operation, as during operation, the first frame portion 116 and the second frame portion 120 may repeatedly articulate with respect to each other thereby expanding the frame clearance, Cl, at one side (e.g., at the left side 140) and compacting the frame clearance, Cl, at the other side (e.g., at the right side).

Unless specified otherwise, terms such as ‘forward’, ‘front’, ‘rear’, ‘rearward’, as used in the present disclosure, may be understood according to an exemplary direction, T, in which the machine 100 may move during operations. Said exemplary direction, T, may be defined from the rearward end 128 towards the forward end 124 of the machine 100. Further, expressions such as ‘left’ and ‘right’, as used in the present disclosure, may be understood as the machine 100 is viewed from the second frame portion 120 towards the first frame portion 116 and/or from the rearward end 128 towards the forward end 124.

The first frame portion 116 may support (e.g., movably support) an implement 148 of the machine 100. The implement 148 may be used to alter and/or move earth. For example, the implement 148 may include a bucket 148′ which may be articulatable with respect to the first frame portion 116 (or to the forward end 124 of the machine 100) to receive, haul, and dump a load. It may be noted that the reference to the bucket 148′ is exemplary, and the machine 100 can include various other types of implements, either alone or in conjunction with the bucket 148′. Apart from the implement 148, the first frame portion 116 may also include mechanisms, e.g., hydraulically actuated mechanisms, by which the implement 148 can be controlled and moved with respect to the first frame portion 116 (or with respect to the forward end 124). Other details related to the implement 148 may be contemplated and applied by those skilled in the art, and thus will not be discussed further.

The second frame portion 120 may support various other parts and/or sub-systems of the machine 100. As an example, the second frame portion 120 may support a power compartment 152 which may house a power unit (not shown) of the machine 100, and from where power for executing various functions, such as machine motion and/or implement control, may be sourced. The power unit may generate motive power by producing electricity and/or by combusting fossil fuels to power the machine 100. According to some embodiments, a part or a whole of the power compartment 152 can also serve as a counterweight of the machine 100. The counterweight may be applied to counteract against a weight of a load received into and/or hauled by the implement 148 (e.g., when the implement 148 includes the bucket 148).

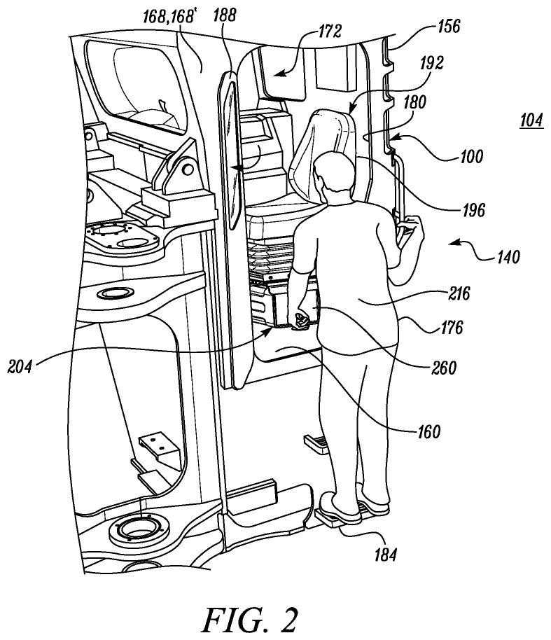

Referring to FIGS. 1 and 2, the second frame portion 120 may also support an operator cab 156 of the machine 100. The operator cab 156 may include a floor portion 160, a roof portion 164, and an assemblage of side panels 168 which connects the floor portion 160 to the roof portion 164. The operator cab 156 may define an interior space 172 (best shown in FIG. 2). The interior space 172 may be confined and delimited by the floor portion 160, the roof portion 164, and the side panels 168. The interior space 172 may be used to station and/or house one or more operators (e.g., see example operator 176, see FIG. 2) of the machine 100. Moreover, the floor portion 160, the roof portion 164, and the side panels 168, may restrict the influx of several external elements such as dust and debris of the worksite 104 (e.g., of an underground mining worksite) into the confined, interior space 172 of the operator cab 156. Further discussion in the present disclosure may include multiple references to the operator 176. Said reference to the operator 176 may imply a single operator or multiple operators.

In one example, the operator cab 156 may generally acquire a position relatively close to the first frame portion 116 and/or may be disposed adjacent to (or right next to) the frame clearance, C, defined between the first frame portion 116 and the second frame portion 120. The expression ‘relatively close’ may mean that the operator cab 156 is closer to the first frame portion 116 than several other main parts and/or sub-systems (e.g., the power compartment 152) supported on the second frame portion 120. The operator cab 156 may also include one or more input devices, such as joysticks, touchscreens, switches, control panels, etc., accessing one or more of which may enable the operator 176 (e.g., when stationed within the interior space 172 of the operator cab 156) to control one or more of the functions of the machine 100, for example, the aforesaid functions of machine motion and/or implement control.

Further, the operator cab 156 may define an opening 180. As an example, the opening 180 may be formed in one or more of the side panels 168 (e.g., side panel 168′) of the operator cab 156. The opening 180 may be used by the operator 176 to either enter into and access the interior space 172 of the operator cab 156 or pass through and exit out from the interior space 172 of the operator cab 156. With regard to such entry and exit, the operator cab 156 may include steps 184 provided (e.g., affixed) on one or more of the side panels 168 (e.g., side panel 168). The steps 184 may be used by the operator 176 to climb on and gain access to the opening 180 so as to enter inside and/or into the interior space 172 through the opening 180. Conversely, the steps 184 may also be used by the operator 176 when exiting the interior space 172 and alighting from the operator cab 156. In some embodiments, the operator cab 156 may include a door 188 which may be moved to selectively switch the opening 180 between an open state and a closed state (a state of the opening in FIGS. 1 and 2 corresponds to the closed state and the open state, respectively). A movement of the door 188 to switch the opening 180 to the open state may be exemplarily defined outwardly of the interior space 172 of the operator cab 156, as is also shown in FIG. 2. In some examples, the opening 180, in the open state, may face the frame clearance, C, and thus may open towards and/or into the frame clearance, C.

The operator cab 156 may also include a seating assembly 192. The seating assembly 192 may be used by the operator 176 for being seated within the interior space 172 of the operator cab 156. The seating assembly 192, or one or more of its parts, may be accessed by the operator 176 through the opening 180 (see FIG. 2). In this regard, the operator 176 may access the seating assembly 192 or said one or more parts of the seating assembly 192 while standing outside the operator cab 156, e.g., while standing on the steps 184. Additionally, or optionally, the operator 176 may also access the seating assembly 192 or said one or more parts of the seating assembly 192 when the operator 176 is stationed inside (e.g., fully inside) the interior space 172. The seating assembly 192 may include an operator seating unit 196, a raiser 200, and a utility compartment 204. Details related to each of the operator seating unit 196, the raiser 200, and the utility compartment 204, shall now be discussed.

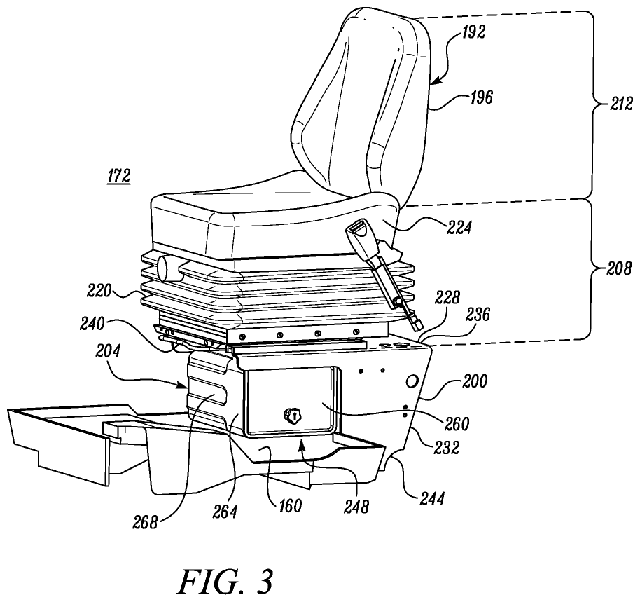

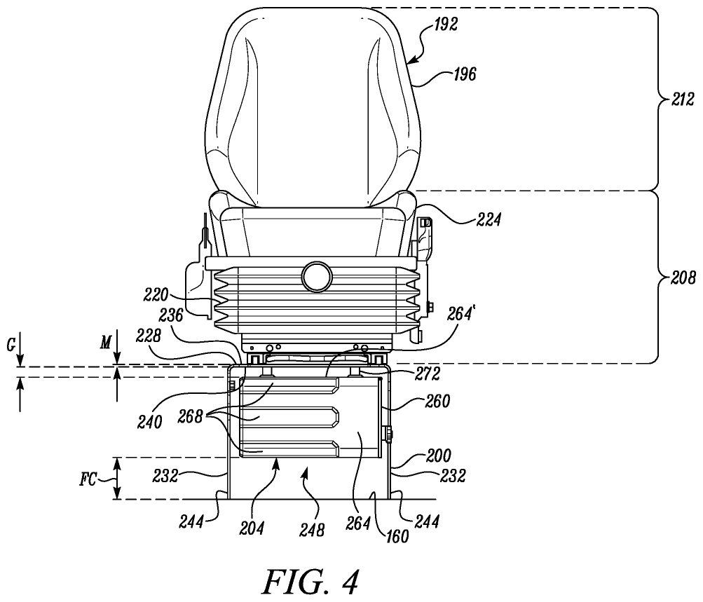

Referring to FIGS. 3 through 5, the operator seating unit 196 may be housed within the interior space 172 of the operator cab 156. The operator seating unit 196 may include a bench portion 208 and a support portion 212. The support portion 212 may be disposed at an angle with respect to the bench portion 208. Both the support portion 212 and the bench portion 208 may be used to rest and/or seat the operator 176 (e.g., a posterior side 216 of the operator's body, see FIG. 2) on the operator seating unit 196. The bench portion 208 may include a cover 220, such as bellows, to shield certain parts, such as a suspension system (not shown), of the bench portion 208. Further, the bench portion 208 (and/or optionally the support portion 212) may define a lateral side, e.g., a forward facing lateral side 224, but which may be located exemplarily at a left side for the operator 176 when the operator 176 is seated on the operator seating unit 196. Said forward facing lateral side 224 may face or be directed towards the opening 180 of the operator cab 156.

Although not limited, an orientation of the operator seating unit 196 and/or the bench portion 208 and the support portion 212 may be such that, when the operator 176 is seated on the bench portion 208, the operator 176 may face or be directed towards one of the lateral sides of the machine 100. As an example, the operator may face the right side (hidden behind the left side 140 in FIG. 1) of the machine 100. In that manner, as the door 188 may be moved to switch the opening 180 to the open state, the forward facing lateral side 224 of the bench portion 208 (and optionally the support portion 212) may be first viewed and/or be accessed by the operator (e.g., for entry or ingress into the interior space 172 and then exemplarily for being seated on the operator seating unit 196).

The raiser 200 may be configured to mount the operator seating unit 196 on the floor portion 160 of the operator cab 156 and also raise the operator seating unit 196 with respect to the floor portion 160 of the operator cab 156. In so doing, the raiser 200 helps an operator (e.g., the operator 176) seated on the operator seating unit 196 to view an outside environment of the operator cab 156, e.g., through a windshield or a window (not shown) of the operator cab 156, with relative ease. In further detail, the raiser 200 may define a base 228 and a pair of spaced apart legs (referred to as legs 232, hereinafter).

The base 228 may include a generally planarly extending structure, exemplarily defining a first surface 236 and a second surface 240. Although not limited, both the first surface 236 and the second surface 240 may be flat surfaces. Further, the second surface 240 may be disposed oppositely to the first surface 236, and a thickness, M, of the base 228 may be defined between the first surface 236 and the second surface 240, as shown. According to an aspect of the present disclosure, the first surface 236 may be used to mount the operator seating unit 196 thereon—e.g., the bench portion 208 of the operator seating unit 196 may be mounted atop the first surface 236 of the base 228 in an assembly of the operator seating unit 196 with the raiser 200 to raise the operator seating unit 196 with respect to the floor portion 160.

The legs 232 may support the base 228 on the floor portion 160 to elevate the base 228 with respect to the floor portion 160. The legs 232 may extend from the base 228, and, in one example, the legs 232 may extend integrally and contiguously from the base 228. Although not limited, the legs 232 may be orthogonally oriented with respect to the base 228. Together, the base 228 and the legs 232 may impart an inverted U-shaped profile to the raiser 200. Further, the legs 232 may define corresponding ends 244 remote to the base 228. To support the base 228 on the floor portion 160, ends 244 of the legs 232 may be coupled (e.g., immovably coupled) to the floor portion 160 (e.g., through a set of suitable fasteners and/or by welding). By way of coupling the ends 244 of the legs 232 with the floor portion 160, the legs 232 may support the raiser 200 on the floor portion 160, while also elevating the base 228 with respect to the floor portion 160. Given that the base 228 may be elevated with respect to the floor portion 160, the first surface 236 defined by the base 228 may also be elevated from the floor portion 160. Said elevation enables the operator seating unit 196 mounted on the first surface 236 to be raised with respect to the floor portion 160. When the raiser 200 is positioned on the floor portion 160, the raiser 200 (e.g., the base 228 and the legs 232) in conjunction with the floor portion 160 may define and/or delimit a space therebetween. Said space may be referred to as an under seat space 248, hereinafter.

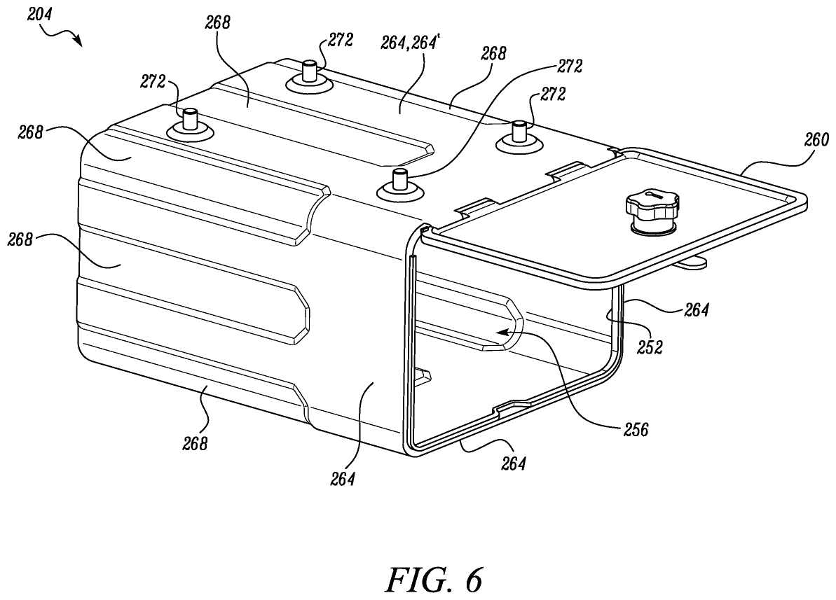

Referring to FIGS. 3 through 6, the utility compartment 204 may be positioned between the first surface 236 and the floor portion 160. More particularly, the utility compartment 204 may be located within the under seat space 248 to be positioned between the first surface 236 of the base 228 and the floor portion 160. Although not limited, the utility compartment 204 may define a cuboidal shape. Further, the utility compartment 204 may define an aperture 252. The aperture 252 may be directed towards the opening 180 of the operator cab 156. Also, the utility compartment 204 may be coupled with the base 228 to be suspended under the base 228. In so doing, the utility compartment 204 may lie adjacent to or against the second surface 240 of the base 228. Moreover, the utility compartment 204 may define a clearance (referred to as a floor clearance, FC) with respect to the floor portion 160.

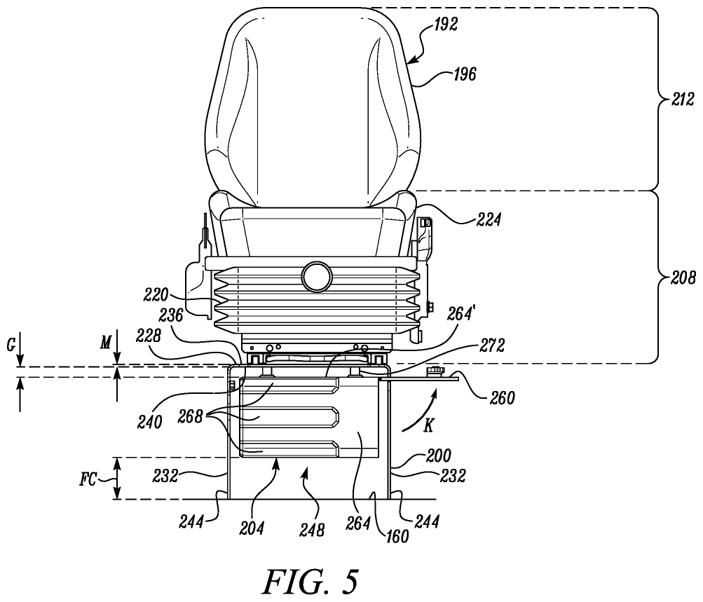

Further, the utility compartment 204 defines an internal volume 256. The utility compartment 204 also includes a lid 260 to selectively open and/or close the aperture 252 to correspondingly gain and/or restrict access to the internal volume 256. The lid 260 may include any suitable clasping mechanism, now known or in the future developed, to close the aperture 252 and thus lock the internal volume 256 from an outside environment. According to some embodiments, the lid 260 may open outwards of the internal volume 256 of the utility compartment 204 to be directed towards the opening 180—see exemplary opening direction, K, of the lid 260 in FIG. 5. Also, the utility compartment 204 may define outer walls 264 (e.g., integrally and contiguously merged with each other) to surround the internal volume 256. Each of said outer walls 264 may define intermittently arranged ridges or corrugated surfaces 268 to impart strength, and/or rigidity to an overall structure of the utility compartment 204. Further, the utility compartment 204 may be made from any suitable metallic and/or non-metallic material. One example material may include plastic polyethylene.

With regard to an exemplary coupling of the utility compartment 204 with the base 228, fastener units 272 may be used. As an example, the fastener units 272 may be four in number, although a higher or lesser number of fastener units may be used. Each of the fastener units 272 may exemplarily include a fastener (e.g., a threaded fastener), a spacer, and a nut (these are not explicitly shown). For example, the fastener may be driven through one of the outer walls (e.g., outer wall 264′) of the utility compartment 204 and across the thickness, M, of the base 228. A portion of the fastener revealed outwardly of the first surface 236 may be retained thereof by the nut. The spacer may be exemplarily provided around the fastener as a sleeve, and when the utility compartment 204 is coupled with the base 228, the spacer may help to define a gap, G, between the base 228 (e.g., the second surface 240 of the base 228) and the corresponding outer wall (e.g., outer wall 264′) of the utility compartment 204. The gap, G, may provide space to accommodate a hinged connection between the lid 260 and the outer wall 264′ and/or may allow the lid 260 to be opened freely and outwardly of the internal volume 256 of the utility compartment 204 without restriction or hinderance to any part disposed adjacent to the utility compartment 204.

In some embodiments, the fastener units 272 may include other fastening methods so as to fasten and secure the utility compartment 204 to the base 228. As an example, the fastener units 272 may include magnetic fastener units, and accordingly, a coupling of the utility compartment 204 with the base 228 may be attained magnetically. The arrangement of the fastener units 272 and/or a methodology of fastening the utility compartment 204 to the base 228 is thus not to be seen as limiting in any way.

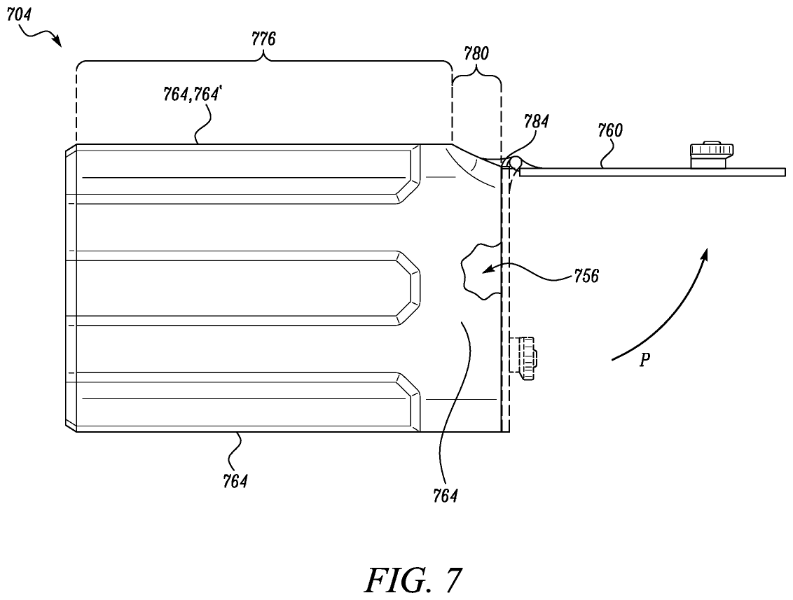

Referring to FIG. 7, an embodiment of the utility compartment 204 is shown and described by way of a utility compartment 704. With regard to parts and/or features of the utility compartment 704 that are same or similar to the utility compartment 204, same or similar reference numerals and corresponding nomenclatures may be applied. The utility compartment 704 may include all parts/features as are provided with the utility compartment 204. However, the utility compartment 704 may omit one or more of the outer walls 264 (e.g., the outer wall 264′) and one or more related features thereof of the utility compartment 204. For example, in place of one or more of the outer walls 264, the utility compartment 704 may correspondingly include one or more outer walls 764, as shown, and particularly, in place of the outer wall 264, the utility compartment 704 may include an outer wall 764′. Further, the utility compartment 704 may include a lid 760, as shown.

The outer wall 764′ may define a first wall portion 776 and a second wall portion 780. The second wall portion 780 may be tilted or angled with respect to the first wall portion 776. As an example, the second wall portion 780 may be angled to the first wall portion 776 such that the second wall portion 780 may extend or be directed inwards into an internal volume 756 of the utility compartment 704 to indent said internal volume 756. The lid 760 may be hinged with respect to an edge 784 of the second wall portion 780. The angled profile or the indentation of the second wall portion 780, as provided and described above, may provide space to accommodate a hinged connection between the lid 760 and the edge 784 and/or may allow the lid 760 a restriction free outward movement (e.g., a pivotal outward movement, see direction, P) with respect to the internal volume 756 of the utility compartment 704. Said movement may be executed without any restriction or hinderance to any part disposed adjacent to the utility compartment 704. According to some embodiments, the utility compartment 704 (or the configuration of the outer wall 764′ as discussed above) may be applicable when the gap, G, is non-existent.

### INDUSTRIAL APPLICABILITY

The operator 176 may use the utility compartment 204 to store essential items such as food packets, water bottles, first aid kit, and the like. Provision of such items in ready access to the operator 176 imparts a general sense of comfort and/or security to the operator, and/or to also other operators or supervisors of the worksite 104. This may be applicable particularly when the working conditions of the operator 176 are rigorous and/or are relatively long. Further, because the aperture 252 of the utility compartment 204 is directed towards the opening 180 of the operator cab 156, the operator 176 can readily access the contents housed within the internal volume 256 of the utility compartment 204 both when the operator 176 is stationed outside the utility compartment 204 (e.g., on the steps 184) and also when the operator 176 is stationed inside the interior space 172 (e.g., on the operator seating unit 196 of the seating assembly 192) of the operator cab 156. Such positioning of the aperture 252 is useful also in cases where there is limited space available in the interior space 172 of the operator cab 156. Additionally, the position of the aperture 252 in the aforementioned manner keeps the lid 260 of the utility compartment 204 away from interfering with any of the controls or input devices provided within the operator cab 156.

To access and/or retrieve the contents of the internal volume 256 of the utility compartment 204, e.g., when the operator 176 is seated within the interior space 172 on the operator seating unit 196 of the seating assembly 192, instead of bending forward or elsewhere and potentially interfering with the controls or input devices of the operator cab 156, the operator 176 can keep away from such interference by bending conveniently sideways, i.e., towards the forward facing lateral side 224 of the bench portion 208 (and/or the support portion 212) or in the direction of the door 188 or opening 180 of the operator cab 156. In case there are controls or input devices provided on the door 188, the operator 176 may first open the door 188 to make way for the sideway bending (e.g., towards the forward facing lateral side 224) to access the contents of the internal volume 256 of the utility compartment 204.

Further, the utility compartment 204 is provided within the under seat space 248, thus efficiently utilizing the space under the operator seating unit 196 (i.e., the under seat space 248) which is commonly left underutilized or non-utilized in operator cabs of underground mining machines. Such utilization of unused space is of significant benefit because, typically, there is limited space available in the interior space (e.g., interior space 172) in operator cabs of underground mining machines.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

1. An operator cab for an underground mining machine, the operator cab comprising:
a floor portion;
an opening to access an interior space of the operator cab;
a seating assembly for the operator cab, the seating assembly including:
an operator seating unit mounted on the floor portion and housed within the interior space of the operator cab;
a raiser defining a surface to mount the operator seating unit thereon, the surface being elevated from the floor portion to raise the operator seating unit with respect to the floor portion; and
a utility compartment positioned between the surface and the floor portion, the utility compartment defining an aperture directed towards the opening.

2. The operator cab as claimed in claim 1, wherein the operator seating unit includes a bench portion and a support portion disposed at an angle with respect to the bench portion, the bench portion defining a lateral side facing the opening.

3. The operator cab as claimed in claim 1, wherein the raiser includes a base defining the surface and a pair of spaced apart legs extending from the base, the pair of spaced apart legs supporting the base on the floor portion,
wherein an under seat space is defined and delimited by the pair of spaced apart legs, the base, and the floor portion.

4. The operator cab as claimed in claim 3, wherein the utility compartment is located within the under seat space to be positioned between the surface and the floor portion, the utility compartment being coupled with the base to be suspended under the base and defining a clearance, FC, with respect to the floor portion.

5. The operator cab as claimed in claim 1, wherein the utility compartment defines an internal volume and includes a lid to selectively open and close the aperture to correspondingly gain and restrict access to the internal volume, wherein the lid is directed towards the opening and opens outwards of the internal volume of the utility compartment.

6. The operator cab as claimed in claim 5, wherein the utility compartment defines a plurality of outer walls surrounding the internal volume, at least one outer wall of the plurality of outer walls defining a first wall portion and a second wall portion angled with respect to the first wall portion, the lid being hinged with respect to an edge of the second wall portion.

7. The operator cab as claimed in claim 6, wherein the second wall portion is angled to the first wall portion such that the second wall portion extends or is directed inwards into the internal volume to indent the internal volume of the utility compartment.

8. The operator cab as claimed in claim 6, wherein each outer wall of the plurality of outer walls defines one or more corrugated surfaces.

9. An underground mining machine, comprising:
an implement to alter earth;
a first frame portion and a second frame portion articulatable with respect to the first frame portion, the first frame portion movably supporting the implement;
an operator cab supported by the second frame portion, the operator cab including:
a floor portion;
an opening to access an interior space of the operator cab;
a seating assembly for the operator cab, the seating assembly including:
an operator seating unit mounted on the floor portion and housed within the interior space of the operator cab;
a raiser defining a surface to mount the operator seating unit thereon, the surface being elevated from the floor portion to raise the operator seating unit with respect to the floor portion; and
a utility compartment positioned between the surface and the floor portion, the utility compartment defining an aperture directed towards the opening.

10. The underground mining machine as claimed in claim 9, wherein the operator seating unit includes a bench portion and a support portion disposed at an angle with respect to the bench portion, the bench portion defining a lateral side facing the opening.

11. The underground mining machine as claimed in claim 9, wherein the raiser includes a base defining the surface and a pair of spaced apart legs extending from the base, the pair of spaced apart legs supporting the base on the floor portion,
wherein an under seat space is defined and delimited by the pair of spaced apart legs, the base, and the floor portion.

12. The underground mining machine as claimed in claim 11, wherein the utility compartment is located within the under seat space to be positioned between the surface and the floor portion, the utility compartment being coupled with the base to be suspended under the base and defining a clearance, FC, with respect to the floor portion.

13. The underground mining machine as claimed in claim 9, wherein the utility compartment defines an internal volume and includes a lid to selectively open and close the aperture to correspondingly gain and restrict access to the internal volume, wherein the lid is directed towards the opening and opens outwards of the internal volume of the utility compartment.

14. The underground mining machine as claimed in claim 13, wherein the utility compartment defines a plurality of outer walls surrounding the internal volume, at least one outer wall of the plurality of outer walls defining a first wall portion and a second wall portion angled with respect to the first wall portion, the lid being hinged with respect to an edge of the second wall portion.

15. The underground mining machine as claimed in claim 14,
wherein the second wall portion is angled to the first wall portion such that the second wall portion extends or is directed inwards into the internal volume to indent the internal volume of the utility compartment; and
wherein each outer wall of the plurality of outer walls defines one or more corrugated surfaces.
